(19) United States
(12) Patent Application Publication
(10) Pub. No.: US 2008/0261427 A1
(43) Pub. Date: Oct. 23, 2008

(54) One-way to Three-way Light Bulb Adaptor

(76) Inventor: Albert E. Adams, Lyndonville, VT (US)

Correspondence Address: DANIEL S. COOLIDGE;COOLIDGE & GRAVES PLLC, 36 OLD CHANDLERS MILLS ROAD, UNITY, NH, 03743, US

(21) Appl. No.: 11/873,514

(22) Filed: Oct. 17, 2007

Related U.S. Application Data
(60) Provisional application No. 60/852,367, filed on Oct. 17, 2006.

(51) Int. Cl. H01R 33/72; H01R 13/66

(52) U.S. Cl. 439/236; 439/620.02

(57) ABSTRACT

A method and system is described of adapting a three way lamp socket to be able to utilize a plurality of “single-element” light bulbs.

This application claims priority from Provisional Application 60/852367 filed Oct. 17, 2006.

### BACKGROUND OF THE INVENTION

Current household lamps often incorporate an inverted U-shaped metal harp which is fixed to the lamp body at the base of the lamp holder, to the top of which a lamp shade is attached. A weighted base allows for stable placement of the lamp assembly on either the floor or a piece of furniture.

A three-way bulb holder/switch is often found in this type of lamp. When a three-way lamp socket is fitted with an incandescent three-way light bulb, three levels of illumination are produced by the lamp. The three-way incandescent light bulb is manufactured with two separate filaments within the glass enclosure. One of the filaments typically produces twice as much light when energized as the other.

The standard three-way bulb holder has four switch positions: off, low, medium, and high. By utilizing the outside of the light bulb's screw-in base as a common electrical ground, with two concentric electrical contacts on the bulb's tip, the three-way bulb holder enables independent activation of the two separate filaments within the incandescent bulb. The dimmer of the two filaments is energized to produce “low” light output. The brighter filament is energized to produce “medium” light output. Both filaments are energized simultaneously to produce “high” light output.

With the increasing costs of excessive electrical power, increased attention is being paid to the benefits of replacing incandescent light bulbs with more energy efficient bulbs. The major advantage of the compact fluorescent bulb over its incandescent equivalent is that it typically uses approximately 25% of the electricity consumed by the incandescent bulb for the same amount of light output.

Costs associated with the use of “single-element” compact fluorescent lamps (CFLs) continue to decline. At this time the higher cost of compact fluorescent bulbs is rapidly being offset by the substantially lower operational costs, often as low as one quarter of an incandescent bulb, making the compact fluorescent bulb an attractive alternative to their incandescent cousins, at least when used in a one-way (off-on) lamp holder.

Traditional three-way incandescent bulbs suffer from the problem that if one of the two lighting elements fail, the bulb must be replaced, even though one working element remains. Also, existing three-way bulbs are limited in their lighting choices. Consumers wish a way to set different levels of light for different situations—low light for conversation, high level of light for reading.

What is needed is a way of easily providing for multiple levels of light from a single lamp using CFLs. Moreover, what is needed is a means of beneficially utilizing a three-way lamp base with CFLs to provide different levels of illumination without having to have three-way bulbs that must be replaced if a single element fails.

### BRIEF DESCRIPTION OF THE INVENTION

The present invention supports the use of a plurality of energy-efficient “single-element” compact fluorescent light bulbs in light fixtures that are designed to utilize a single three-way bulb, typically within the confines of a fabric-covered, wire-framed lamp shade. A “single-element” CFL, for the purposes of this document, refers to one which is capable of a single level of illumination when energized. The invention will also allow for use of the next generation of LED-based light bulbs when they become available. With suitable lamp shades, existing incandescent bulbs may also be used.

In one embodiment, three single-bulb sockets are combined in a single three-way bulb based fixture, allowing sequentially a single top bulb to be lit, two side bulbs, and all three. Different combinations of bulb wattages may be used so as to get desired lighting effects, even unbalanced effects if desired.

By using different combinations of bulbs, a consumer is offered a wider variety of lighting choices such as light distribution, warmer or cooler color temperature and combinations of bulb wattages.

### BRIEF DESCRIPTION OF THE ILLUSTRATIONS

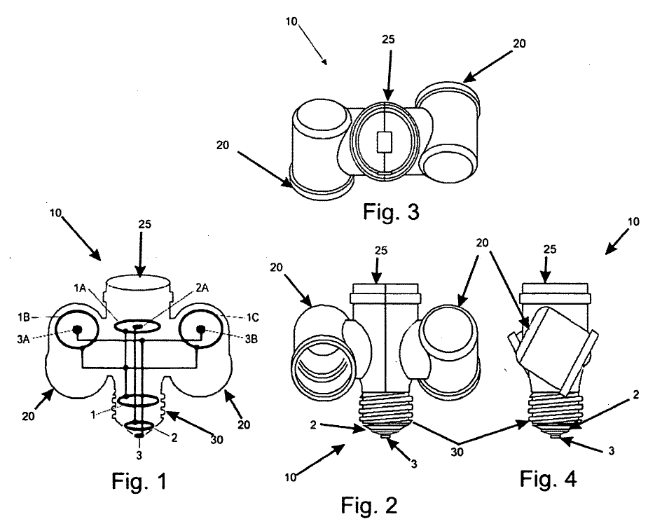

FIG. 1 is an electrical schematic diagram and outline of one embodiment of the present invention.

FIG. 2 is a side view of a three-bulb embodiment of the present invention.

FIG. 3 is a top down view of a three-bulb embodiment of the present invention.

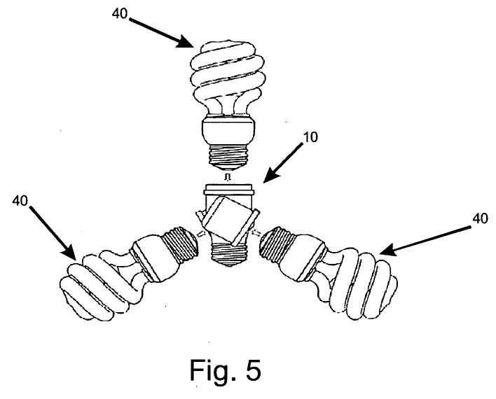

FIG. 4 is a side view of a three bulb embodiment of the present invention, orthogonal to FIG. 2.

FIG. 5 is a side view of a three-bulb embodiment of the present invention showing placement of the bulbs.

### DETAILED DESCRIPTION

Referring to FIGS. 1, 2, 3 and 4 an electrical schematic diagram 10 of one embodiment of the present invention is shown, together with an outline of a physical implementation. While the invention as shown utilizes three bulbs, it may be beneficially implemented with two or more bulbs.

As is standard with a three-way light bulb, the base 30 is fitted with three electrical contacts 1,2 and 3. A common contact 1 is made from the screw-portion of the base, and two hot contacts 2,3 are implemented in the tip portion of the light bulb base 30. The three-way switch of a lamp base (not shown) has four positions: a first position, in which no power is provided; a second position in which power is provided only a first of the hot contacts 2; a third position in which power is provided to a second of the hot contacts 3; and a fourth position, in which power is provided to both the hot contacts 2,3.

In the embodiment shown, the first hot contact 2 is connected to a central socket 25, thus powered in the second and fourth switch positions. The second hot contact 3 is connected to side sockets 20, thus powered in the third and fourth switch positions. In this embodiment, in the first switch position none of the sockets are energized, only the central socket 25 is powered in the second switch position, only the side sockets 20 are powered in the third switch position, and all three sockets 20 and 25 are powered in the fourth switch position, thus giving three different levels of light from “single-element” bulbs.

In this embodiment, three sockets 25 and 20 are used so as to provide a more even illumination when bulbs are inserted and powered. While the present invention can be implemented using two or more sockets, it is preferred to use three so as to provide illumination more evenly on all sides of the lamp (not shown). This may be more easily envisioned by reference to FIG. 5 in which CFLs are shown in relative position in the three-bulb embodiment described. As is shown, the two side bulbs 45 are to be inserted on either side of the three-way socket converter 10, and a central bulb 45 in a central position, thus providing nearly equal illumination on all sides of the lamp (not shown).

The embodiment shown may also beneficially be used with ordinary “single-element” light bulbs, thus eliminating the need for three-way bulbs. Frequently three way incandescent bulbs have a single element burn out, thus making them capable of only a single intensity of illumination. To fix this, the bulb must be replaced, wasting the remaining single useable element. Utilizing the present invention, only “single-element” bulbs need be used, and may be replaced as needed without wastefully discarding a useful bulb.

Care must be taken to assure that a lamp shade is not placed too close to the light bulbs so as to cause a fire hazard. In some instances, it may be necessary to replace the existing lamp shade with a larger diameter shade. CFLs, being of lower wattage to produce the same light output as incandescent bulbs and thus producing less heat, pose less of a need for this precaution.

I claim:

1. A three-way socket converter comprising:
a standard three-way light bulb base having a common electrical connection, a first hot connection and a second hot connection;
at least one primary light socket adapted so as to receive a light bulb, and having a first screw portion having a first electrically conductive common portion, and further having a first tip portion; wherein the said common electrical connection is conductively connected to said first electrically conductive common portion and said first hot connection is conductively connected to said first tip portion;
at least two secondary light sockets wired in parallel and each adapted so as to receive a standard light bulb, and each having a second screw portion having a second electrically conductive common portion; and further having an electrically conductive second tip portion; wherein said second electrically conductive common portion is conductively connected to said common electrical connection and said second hot connection is conductively connected to said second tip portion;
a common insulating housing holding said at least one primary light socket, said at least one secondary light socket, and said light bulb base, wherein said light bulb base is oriented so as to permit it to be screwed into a three-way lamp socket.

2. The three-way socket converter of claim 1 wherein the at least two secondary light sockets are located on opposite sides of said primary light socket.

3. A method of using single-element bulbs in a three-way light socket comprising:
providing at least one primary socket having a first common electrical contact and a first hot electrical contact;
further providing at least two secondary sockets wired in parallel and each having a second common electrical contact and a second hot electrical contact;
further providing a three-way lamp base adapted to fit into a three-way lamp socket, said lamp base having a base common, a base primary and a base secondary electrical contact adapted to mate with corresponding contacts in said lamp socket;
providing a housing, and mounting said at least one primary socket, said at least one secondary socket and said three-way lamp base in said housing so as to permit said three-way lamp base to be screwed into a three-way lamp socket;
providing conductive circuitry within said housing such that the said base common electrical contact is conductively connected to said first and second common electrical contacts; and further providing conductive electrical circuitry within said housing such that the said base primary contact is conductively connected to said first hot electrical contact; further providing conductive electrical circuitry within said housing such that the said base secondary contact is conductively connected to said secondary hot electrical contact;
inserting said lamp base into a powered three-way lamp socket, and inserting “single-element” light bulbs into said at least one primary socket and said at least one secondary socket, and energizing said at lamp socket.
